(19) United States
(12) Patent Application Publication
(10) Pub. No.: US 2018/0209601 A1
(43) Pub. Date: Jul. 26, 2018

(54) Ledgeline Lighting Assembly

(71) Applicants: David E. Doubek, La Grange, IL (US); David J. Ziobro, Fayetteville, GA (US)

(72) Inventors: David E. Doubek, La Grange, IL (US); David J. Ziobro, Fayetteville, GA (US)

(21) Appl. No.: 15/859,227

(22) Filed: Dec. 29, 2017

Related U.S. Application Data
(60) Provisional application No. 62/449,057, filed on Jan. 22, 2017.

(51) Int. Cl. F21S 8/00; F21V 7/00; F21V 15/01; F21V 21/04; F21V 29/70

(52) U.S. Cl. CPC F21S 8/037; F21V 7/0008; F21Y 2115/10; F21V 21/047; F21V 29/70; F21V 15/012

(57) ABSTRACT

A lighting assembly provides cove lighting without requiring construction of a cove to support or conceal the assembly. A housing can be disposed at a gap in a ceiling or wall and supported by structural framing at the ceiling or wall. The front of the housing can be mudded and painted to blend in with the ceiling or wall at which it is disposed so that it conceals itself. An assembly can comprise a housing and an illumination component removably coupled thereto. Wiring for the illumination component can be accommodated at a wireway of the channel. A mounting trough at the housing enables mounting of the housing at the framing without penetration of the channel. A molding base can be attached to the housing at the trough, and crown molding attached to the base.

### CROSS REFERENCE TO RELATED APPLICATIONS

This application claims priority from U.S. Provisional Application No. 62/449,057, “Ledgeline Lighting Assembly, filed Jan. 22, 2017 to Doubek et al., which is herein included in its entirety by reference.

### FIELD OF INVENTION

This invention relates generally to cove lighting apparatus, and more particularly to cove lighting apparatus that can be mounted with minimal additional framing.

### BACKGROUND OF INVENTION

Cove lighting apparatus provide indirect ambient lighting that can provide both primary lighting and secondary lighting. Typically, cove lighting fixtures are disposed at the periphery of a room, such as on walls near the ceilings or baseboards, and are mounted in a constructed cove or recess so that the fixtures themselves can be supported and concealed while the light they emit can reflect off a ceiling, wall, floor or other surface. The fixtures can be positioned at a wall or architectural surface that can be variably shaped to have linear, arcuate, geometrical or other profiles.

Generally, a cove lighting fixture includes a light source, circuitry to drive the light source, and some sort of housing to accommodate the light source and circuitry. Typically, when cove lighting is added to a room, a recess or cove must be constructed and fixed to the existing walls or ceiling to support and conceal the light fixture. For example, additional framing and wallboard can be used to create a cove adjacent a wall or ceiling in which the light fixture can be installed so that its light shines toward the surface or surfaces to be illuminated. A tray ceiling can support and conceal a cove lighting fixture between its planes. A desired illumination pattern and the physical size and circuitry of the cove lighting fixtures drives the size and height requirements of the cove that must be built. Sometimes a cove must be quite a bit lower than an existing ceiling to achieve the required distance between a light fixture and the ceiling for a desired light spread and illumination pattern. Unfortunately, a low cove can make a space feel smaller and shadowy despite the additional light that the cove fixture provides. In addition, the larger or more complicated the cove, the greater the time and monetary costs associated with its construction and installation.

For example, fluorescent lighting is typically positioned around 12″ from a ceiling, with the cove bottom that supports the fixtures disposed an even greater distance from the ceiling. In addition to having a bottom, a cove generally requires construction of a cove sidewall conceal the lighting disposed therein. Typically, a sidewall for fluorescent lighting coves is around 8″ high. Because LED fixtures are smaller and provide a different illumination pattern, they can be positioned a bit closer, for example around 10 inches from the ceiling. Likewise, cove sidewalls for LED lighting apparatus can be a bit shorter, typically around 4 inches. Nevertheless, the constructed coves remain fairly noticeable.

Many prior art cove lighting fixtures employ a driver proximate the light source. Unfortunately, such a design typically increases the size and profile of the lighting fixture, and thus increases the size of the cove required to conceal it. For example, the Starfire KE100 Knife Edge Cove Lighting fixture is marketed as a low-profile system that can be mounted in soffits, coffers or walls close to the ceiling. However, the need for a driver proximate its LED light source results in an assembly that is 9 inches wide; i.e. the device juts out from a vertical surface at which it is mounted for three-quarters of a foot. Thus, while the device may be installed at a higher height on a wall, the device requires a cove support structure having a width greater than 6 inches. As a result, installation of the device would require construction and installation of support structures around the periphery of the room that would be fairly noticeable.

The prior art includes various attempts to decrease the size and profile of a cove lighting apparatus and its cove so that it can be more easily and inexpensively installed. For example, the Axis Cove Perfek^{t}™ fixture is marketed as a light fixture that can provide more light than previous prior art devices, and yet can be installed in smaller coves. However, at a bit more than 3.5 inches wide and 1.6 inches tall (or thick), it is limited to ceiling applications and must be attached to both an upper ceiling and a lower horizontal surface and suspended therebetween. Without its knife-edge profile option that has improved concealability, it risks being visible to occupants of the room. Conversely, prior art mounted fixtures designed to create a cove lighting effect without the added framing construction, not only lack the seamless construction of a built-in cove, but often create visible seams over longer lengths.

What is needed is a smaller, thinner, more easily concealable lighting device that can be mounted at ceilings or walls to produce a desired illumination pattern and cove lighting effect while requiring little or no additional framing and construction.

### SUMMARY OF THE INVENTION

In an example embodiment, the present invention provides a lighting assembly that can be provided at a gap in a wall or ceiling, obviating the need to construct a dedicated cove. Because the assembly is relatively thin, it can be mounted at structural framing and integrated with the wall or ceiling without adding additional thickness thereto. A lighting assembly can comprise a housing and an illumination component. In a preferred embodiment, the housing has a thickness or depth that approximates the thickness of gypsum or wallboard so that the assembly can become part of the wall or ceiling itself to provide cove lighting without actual cove construction. The housing can be attached to structural framing that supports the wall or ceiling, such as a framing stud, ceiling beam, etc. The lighting assembly can be mounted so that the back plate is in contact with the structural framing, and the front plate is made to appear as part of the ceiling or wall. For example, the front plate can be mudded, sanded and painted to blend with the adjacent wall or ceiling. As the visible surface of the fixture is mudded into the drywall structure, there are no visible seams once the surface is finished in the same manner as the seams of drywall sections, and is painted. In an example embodiment, a portion of a lighting assembly cantilevers beyond a vertical, sloped or horizontal surface to provide a desired illumination profile at a ceiling.

An example lighting assembly comprises a housing configured for integration at a wall or ceiling, and an illumination component having a light source. The housing can include a channel, a mounting zone and a cap. The channel is defined by a front plate, a back plate and a bottom plate. The front plate can support the illumination component. A wireway within the housing can accommodate wiring for the illumination component. The mounting zone can be configured to receive a mounting means, such as a mounting screw, for attaching the housing to structural framing that supports the wall or ceiling. In an example embodiment, a housing can be attached to the framing without penetration of the space within the channel between the front and back plates. The housing can have a thickness or depth that is substantially the same as the wall or ceiling, so that when provided to a gap at the wall or ceiling, the cap can receive a portion of the wall or ceiling adjacent the gap. In an example embodiment the housing is configured to support the illumination component on a surface parallel with a ceiling that is to be illuminated.

A lighting assembly can further include a second mounting zone at which the assembly can be secured at the framing. Applying mounting screws at two separate portions of the housing improves housing stability and reduces the chances that the housing will rock or shift after it is mounted. By way of example, both mounting zones can be separate from the channel, so that the mounting screws will not penetrate the wireway and pose a risk of damage the internal wiring of the fixture.

An example illumination component can comprise a heat sink, a light source, and a lens, that can engage one another to form a unit that can releasably engage the housing, enabling easy removal of the illumination component for maintenance. An example heat sink can comprise a base portion that can engage the front plate, and an endwall oriented at an angle with respect to the base portion. One or more light sources can be provided to the heat sink at the base portion and/or at the endwall depending on a desired illumination pattern. The heat sink conducts heat away from the light sources to the housing. From the housing the heat can be dissipated to the structure at which the housing is mounted. As gypsum is an excellent conductor of heat, embedding an aluminum housing into the gypsum wall board, or drywall, allows the structure to wick away the heat from the lighting assembly.

An example lighting assembly employs a remote driver to power light sources, enabling the assembly to have a thinner or narrower housing. Because it has less thickness and a narrower width, the assembly can be installed at a greater height, i.e. closer to the ceiling that is to be illuminated, and protrude a shorter distance from vertical surfaces. The smaller profile is an advantage over prior art devices that are installed in deeper and wider coves that often seem to “shrink” a room.

In an example embodiment, a ceiling mount housing is configured for mounting at a pre-existing lower ceiling to illuminate a higher ceiling. For example, the ceiling mount housing can be mounted at the bottom surface of a soffit so that the assembly becomes part of the lower ceiling provided by the soffit. By way of example, the housing can be attached to structural framing supporting the soffit, such as a ceiling beam, by providing a mounting screw at a mounting trough. The housing includes a cap configured to receive a portion of the soffit lower ceiling. The cap can comprise a flange at which a second mounting screw can be received. By way of example, the housing can be positioned at the intersection of vertical and horizontal planes of the soffit so that a portion of the front plate of the housing extends past the vertical plane of the soffit.

In an example embodiment, a wall mount housing configured to illuminate a ceiling attaches to framing that supports a wall beneath the ceiling. By way of example, a wall mount housing can be provided at a cut out gap in the wall, with its first and second caps receiving portions of the wall that border the gap. An example wall mount housing can have first and second mounting troughs at opposing ends of the housing for attaching the housing to the framing. In an example embodiment, the housing can be used to attach crown molding to the framing. For example, a molding base can be attached to the housing at a mounting trough, and crown molding subsequently attached to the molding base.

### BRIEF DESCRIPTION OF THE DRAWINGS

FIG. 1 shows an example environment of an example lighting assembly.

FIG. 2 shows prior art cove lighting.

FIG. 3 shows an example ceiling mount housing.

FIG. 4 shows profile view of the example housing of FIG. 3.

FIG. 5 shows a perspective view of an example lighting assembly.

FIG. 6 shows an example assembly mounted at a support structure.

FIG. 7 shows example housings coupled.

FIG. 8 shows an example ceiling mount lighting assembly mounted.

FIG. 9 shows an example lighting assembly.

FIG. 10A shows an example heat sink with light sources.

FIG. 10B shows an example lens.

FIG. 11A shows a possible illumination component position within a housing.

FIG. 11B shows a possible illumination component position within a housing.

FIG. 11C shows a possible illumination component position within a housing.

FIG. 12 shows an example lighting assembly.

FIG. 13A shows an example configuration of a lighting assembly.

FIG. 13B shows an example configuration of a lighting assembly.

FIG. 14 shows a wall mount embodiment of a lighting assembly.

FIG. 15 shows an example housing.

FIG. 16 A shows an environment for a lighting assembly.

FIG. 16B shows example mounted housings.

FIG. 17 shows an example embodiment with crown molding attached.

FIG. 18 shows an example sidewall of a housing.

FIG. 19A shows the front of an example lighting assembly.

FIG. 19B shows the rear of an example lighting assembly.

FIG. 19C is a perspective view of an example lighting assembly.

FIG. 19D is an exploded view of an example lighting assembly.

FIG. 19E is an exploded view of an example lighting assembly.

FIG. 20 is a flow diagram of an example method.

FIG. 21 is a flow diagram of an example method.

### DETAILED DESCRIPTION OF EXAMPLE EMBODIMENTS

Example embodiments of the invention are presented herein; however, the invention may be embodied in a variety of alternative forms, as will be apparent to those skilled in the art. To facilitate understanding of the invention, and provide a basis for the claims, various figures are included in the specification. The figures are not drawn to scale and related elements may be omitted so as to emphasize the novel features of the invention. Structural and functional details depicted in the figures are provided for the purpose of teaching the practice of the invention to those skilled in the art and are not to be interpreted as limitations. While the invention is disclosed in the context of a horizontal structure mounted on an interior wall, it is understood that it can be practiced on both interior and exterior walls, floors, soffits, roofs, and other architectural structures and can be disposed in vertical, diagonal, curved, or other orientations. Directional terms such as “above”, “below”, “under”, “before”, behind”, “horizontal”, “vertical” and other similar terms are not intended to be interpretations as absolutes or limitations, but are simply used for descriptive purposes in describing relational aspects of various features in an example context or embodiment. Many aspects of the invention, such as housing dimensions, access panels, lenses, heat sinks, light sources, methods of mounting, etc. are described in greater detail in U.S. patent application Ser. No. 15/650,254 to Doubek and Ziobro, titled “Floatline Lighting Assembly” filed Jul. 14, 2017, which is incorporated herein in its entirety by reference.

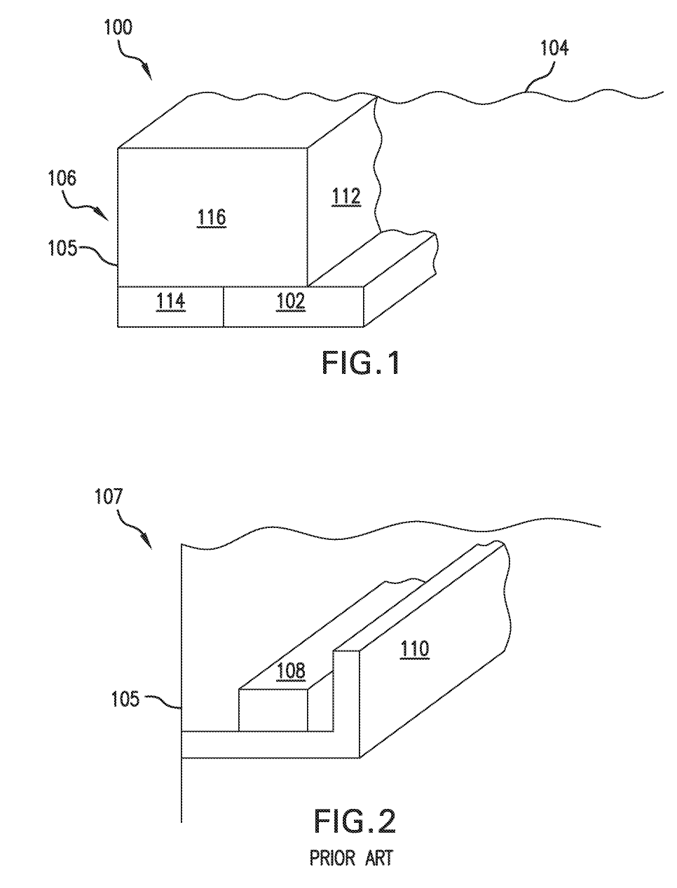

FIG. 1 shows an environment 100 for an example lighting assembly 102. The lighting assembly 102 is configured to illuminate a ceiling 104 and is mounted at a support structure 106 embodied here as a soffit disposed between the ceiling 104 and a wall 105. As can be seen in the drawing, the support structure 106 is not a recess like a typical prior art cove; nor is the lighting assembly 102 held within the support structure 106 as is the case with prior art cove lighting supported within a cove. Instead, the lighting assembly 102 extends out beyond the support structure 106. More specifically, the lighting assembly 102 cantilevers out beyond a vertical surface of the support structure 106, namely wall portion 112.

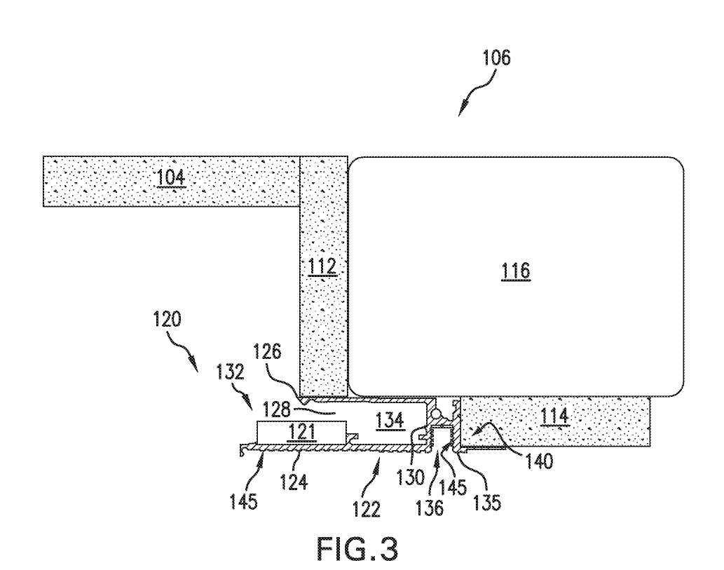

FIG. 2 shows a typical prior art lighting environment 107 in which a cove fixture 108 is positioned within a cove 110 designed to conceal it. The prior art cove 110 is auxiliary construction built specifically for the cove fixture 108. In contrast to the prior art shown in FIG. 2, the support structure 106 for the lighting assembly 102 shown in FIG. 1 can be in the form of standard pre-existing structure. By way of example, but not limitation, the support structure 106 can be in the form of a soffit commonly installed at the perimeter of a room in residential and commercial buildings.

Referring to FIG. 1, the example support structure 106 can be thought of as having the wall portion 112, and a ceiling portion 114. The example support structure 106 can comprise framing 116, which by way of example can comprise wood construction framing such as a ceiling joist, beam, stud or the like, of sufficient strength, stability and rigidity to support the rest of the support structure 106 and/or the ceiling 104 or the wall 105. By way of example, the wall portion 112 can comprise gypsum board, drywall, or other material commonly used in construction that can be coupled to the framing 116 to provide a smooth planar paintable surface.

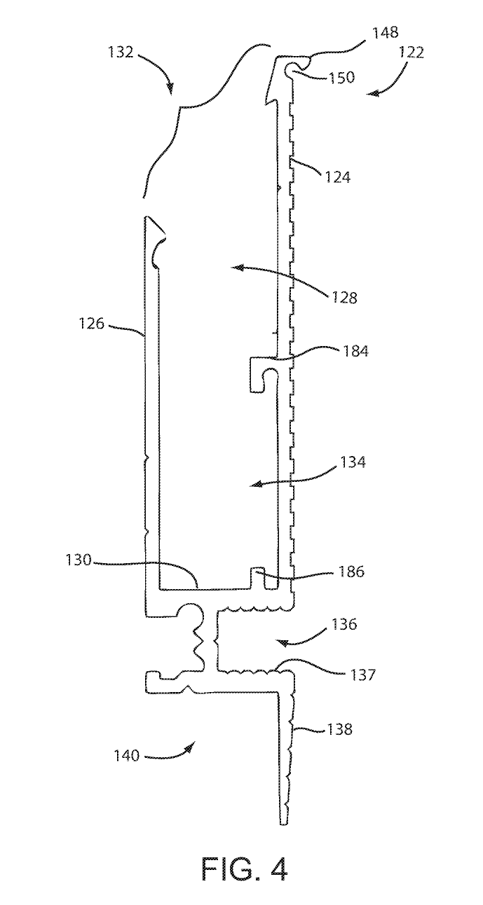

FIG. 3 shows an example embodiment 120 of the lighting assembly 102. The lighting assembly 120 can comprise an illumination component 121 coupled to a housing 122. As shown in FIGS. 3-5, the housing 122 can comprise a front plate 124 and a back plate 126, the space therebetween providing a channel 128. The channel 128 is further bounded by a channel bottom plate 130. The channel 128 has an aperture 132, and a wireway 134 configured to accommodate wiring for an illumination component provided to the housing 122. The housing 122 can further include a mounting trough 136, having a sidewall 137 that cooperates with a flange 138 to provide a cap 140 that receives the ceiling portion 114.

In an example embodiment, and as can be seen in FIG. 3, the housing 122 can have a thickness or depth that is substantially the same as the ceiling and wall portions 114 and 112 at the support structure 106. As a result, instead of the ceiling portion 114 intersecting the wall portion 112, the ceiling portion 114 can be cut smaller and the housing 122 positioned neatly between the ceiling and wall portions 114, 112, adjacent the framing 116, with the cap 140 receiving the ceiling portion 114. The depth of the housing (between front and back plates 124 and 126) fills in a gap in both the ceiling and wall portions 114 and 112. Thus, the lighting assembly 120 can be mounted without increasing the size of the support structure 106 or requiring the construction of any additional cove structure.

In an example embodiment, the distance between the front plate 124 and the back plate 126 can be around 0.625 inches, or the thickness of a typical gypsum board. By way of example, but not limitation, the front plate 124 can extend a minimum length past the edge of the back plate 126, equal to the distance between the front plate 124 and the back plate 126, to provide a minimum cut off angle of 45 degrees to prevent the illumination component 121 from being viewed from most viewing angles. In an example embodiment, the trough 136 can be recessed from the front plate 124 by around 0.36 inches.

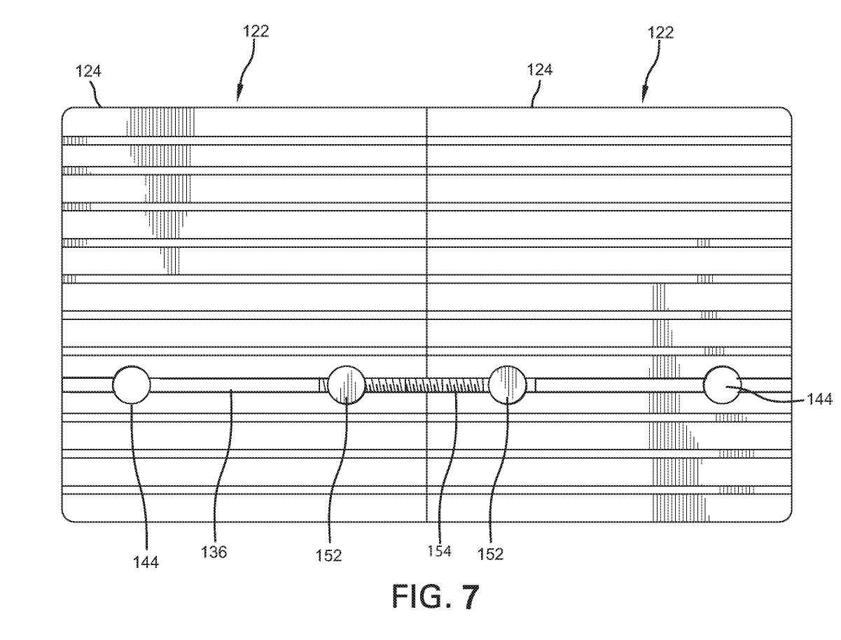

FIG. 6 depicts the example lighting assembly 120 mounted at the support structure 106. In an example embodiment, a first mounting screw 142 can be inserted at the housing 122 at the mounting trough 136 to penetrate the mounting trough 136 and the framing 116. A second mounting screw 142 can be applied to the flange 138 to penetrate the ceiling portion 114 and the framing 116. In an example embodiment, the mounting screw 142 comprises a standard drywall screw. The two mounting zones, i.e. the trough 136 and the lower flange 138, provide stability across both width and length of the housing 122 during and after installation. Providing the mounting screw 142 to the trough 136 positions the front plate and back plates simultaneously, an advantage over prior art fixtures that required front and back plates to be mounted separately.

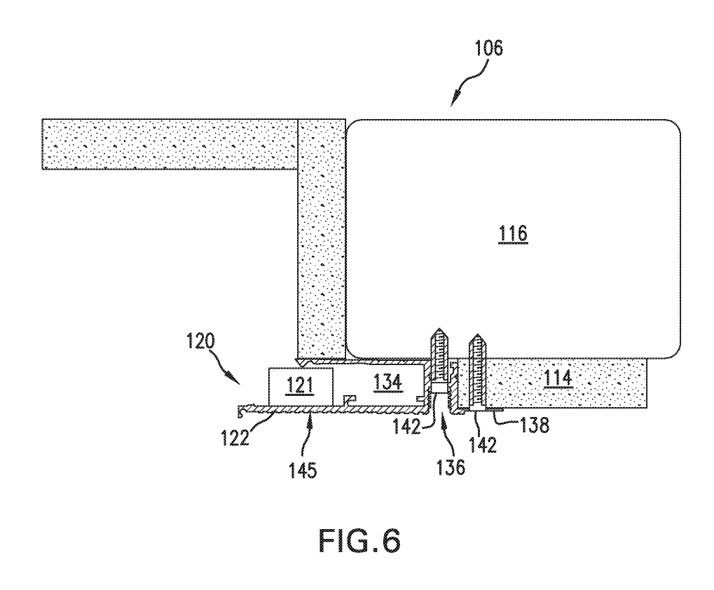

As shown in FIG. 5, the trough 136 can be separated from, and recessed with respect to, the back plate 126 and the front plate 124. Consequently, the mounting screw 142 can be inserted through the trough 136 without contacting or affecting either the back plate 126 or the front plate 124, eliminating the risk of rippling or raised edges in the front plate 124 during the mounting process that can complicate integration into a wall, ceiling or other structure.

In an example embodiment, one or more mounting holes 144 configured to receive mounting screws 142 can be drilled at the trough 136 and the flange 138 either in the field during installation, or at the factory during the manufacture process. In an exemplary embodiment, the mounting trough 136 has a countersunk top so that the head of the mounting screw 142 will lie flush with the trough 136, sparing an operator from having to drill a countersunk hole.

After the housing 122 is mounted at the two mounting zones, the corrugated surface 145 of the front plate 124 can be mudded, sanded and painted to have a finished look that matches the ceiling portion 114. Raised edges can be difficult to mud over without the drywall mud compound subsequently cracking as it dries. Furthermore, raised edges can require an operator to extensively feather the compound to mask height differences between the raised edges and a mounting surface. Fortunately, because the housing 122 can be mounted through the mounting trough 136 without contact with the front plate 124, the present invention can avoid the raised edges that often plagued prior art apparatus.

To facilitate the finishing process, the exterior of the front plate 124 and the flange 138 can have a corrugated surface 145 to improve retention of drywall mud, as shown in FIG. 5. Similarly, the trough 136 may have a corrugated surface 145, as shown in FIG. 3. After the installation process is completed, the housing 122 is concealed from view by the drywall mud and paint applied directly to it, not by additional structure that has been constructed to conceal it.

The short distance between the front and back plates 124 and 126 corresponds to a relatively shallow thickness or vertical dimension when the housing 122 is ceiling mounted as shown in FIG. 3. This shorter vertical dimension, and the manner in which that the lighting assembly 120 is integrated with the ceiling portion 114 enables the lighting assembly 120 to provide a desired light spread while mounted at a higher height than that of prior art devices that required deeper coves to provide the same spread pattern. In other words, prior art devices mounted in coves that had a greater vertical depth than that of the present device, were mounted in ceilings that had to be at a lower height to ensure that light provided by the prior art device had sufficient distance from the ceiling to spread out beyond the cove. Because an assembly of the invention can be positioned at a higher height, a room that it illuminates can have a higher ceiling that provides feelings of brightness and spaciousness to its occupants. As a result, the present invention avoids the disadvantages of the lower ceilings associated with prior art devices.

It is contemplated that multiple lighting assemblies can be coupled to provide long runs of lighting at the periphery of a room. In an exemplary embodiment, the housing 122 can include one or more aspects that facilitate the coupling of adjacent units in a manner that is not only simple to perform, but also results in accurately aligned housings 122. Referring to FIG. 5, the front plate 124 can comprise a front lip 148 comprising an alignment receptor 150 that can be configured to receive an alignment means (not shown). An alignment means can be embodied in various forms. For example, an alignment means can be in the form of a pin, stand-alone or integrated at the housing 122, having a first portion that can be received at a first alignment receptor 150 at a first housing 122 and a second portion that can be received at a second alignment receptor 150 at a second housing 122. In an example embodiment, the housing 122 can be configured with an alignment tab (not shown) and an alignment tab receptor configured to receive an alignment tab. An alignment tab of a first housing can be inserted at an appropriately configured alignment receptor of a second adjacent housing. Other alignment means will occur to those skilled in the art.

While some prior art devices can include a tab that can be used by an installer to align adjacent housings, they typically do not provide a means by which adjacent housings can be physically coupled. When housings are aligned, but not actually connected to one another, their positions relative to each other can shift during the installation process. This shifting can cause result in housings that become misaligned by the time the installation process is finished.

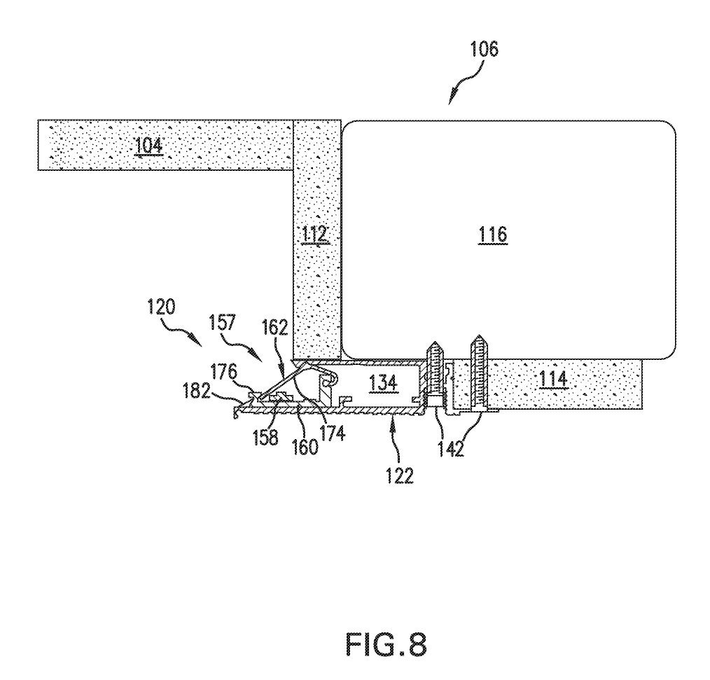

The present invention avoids such problems by providing assemblies that can be positively connected to one another. In an example embodiment, as shown in FIG. 7, the mounting trough 136 can be used to positively couple adjacent housings. For example, the face of the mounting trough 136 can be drilled large enough to accommodate a barrel nut 152 therein. A coupling bolt 154 can be provided to adjacent troughs 136 at the adjacent housings 120. Barrel nuts 152 can be can be tightened to provide a rigid and straight connection between the adjacent housings 122 and maintain the coupling bolt 154 positioning. Coupling adjacent housings 122 using a hex head wrench or similar tool to tighten the coupling bolt through the trough 136 enables adjacent housings 122 to be bolted together without contacting the front plate 124 or back plate 126 of either the first or second housing 122.

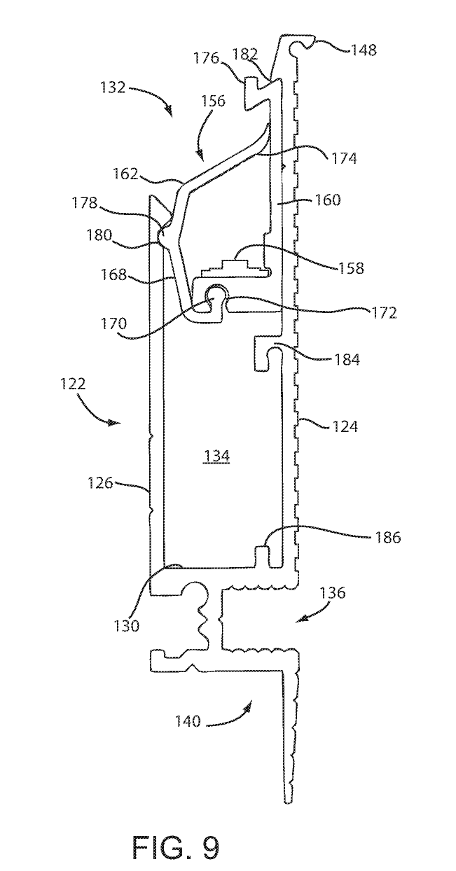

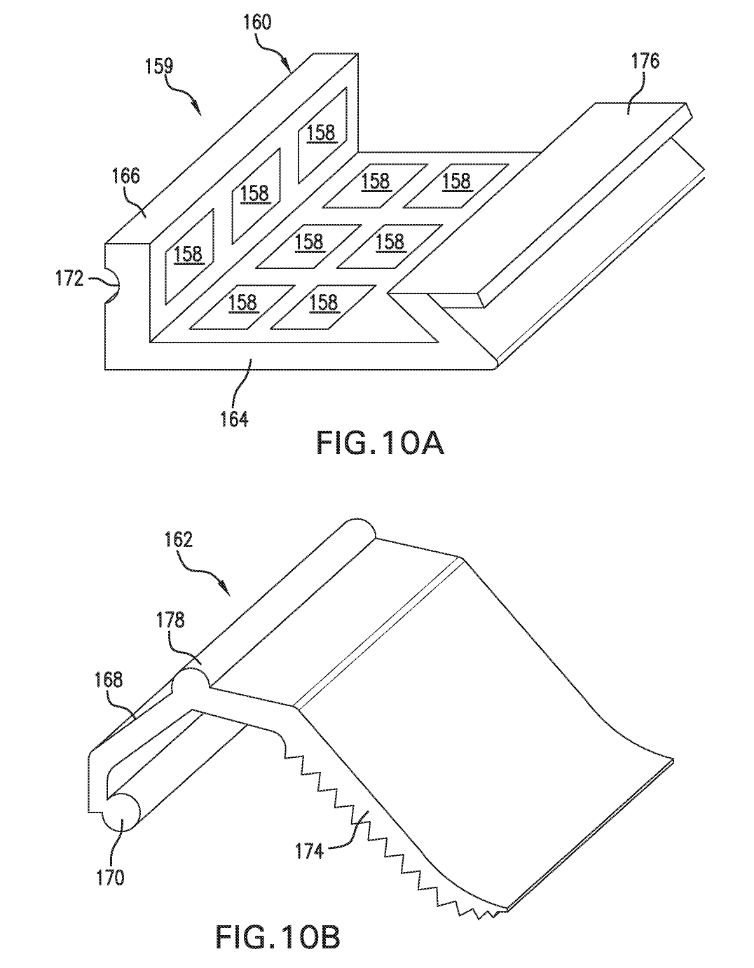

FIGS. 8 and 9 show an example embodiment the housing 122 with an example illumination component. The illumination components 156 and 157 can include a light source 158 a heat sink 160, and a lens 162. As discussed herein, a light source is an element or elements configured to produce light or electromagnetic radiation, such as, but not limited to light-emitting diode (LED) sources, incandescent sources, phosphorescent sources, fluorescent sources, electroluminescent and other luminescent sources, high-intensity discharge sources, etc. For illustrative purposes, the present disclosure will describe an embodiment in which a light source is in the form of an LED, which can include variably packaged LEDs configured to emit various spectra of radiation. By way of example, but not limitation, one or more red-green-blue (RGB) LEDs can be disposed as well as various tones of white LEDs. For purposes of discussion herein, “LED” can refer to a single LED or to one or more LEDs arranged in an array. By way of non-limiting example, the light source 158 can comprise an LED strip comprising one or more LEDs disposed on a flexible tape or backing that can be cut in a predetermined length. It is contemplated that the light source 158 is configured with a means for connection with an external source of power, as known in the art.

In general, light elements, particularly LEDs, are prone to fail when they overheat. The lighting assembly 120 addresses this concern by providing an assembly in which light-producing elements are arranged so that heat is conducted away from them. In an example embodiment, the light source 158 can be disposed directly on the front plate 124 of the housing 122. The housing 122 can dissipate heat to the support structure 106 and to the adjacent ceiling 114 or wall portion 112, which are typically composed of heat conducting gypsum (ground up stone). However, as shown in FIGS. 8, 9 and 10A, in a preferred embodiment, an assembly of the invention includes a heat sink 160 that can more quickly dissipate heat generated at the light sources 158.

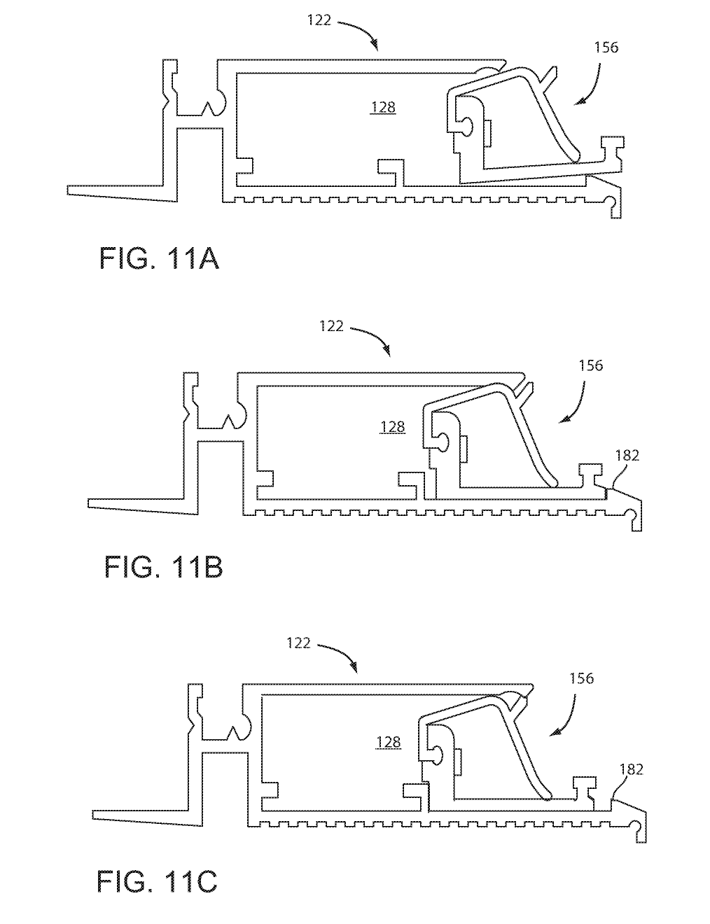

Referring to FIG. 10A, the heat sink 160 can comprise a base 164 and an endwall 166 disposed at an angle to said base 164. In the exemplary embodiment shown in FIG. 10A, the endwall 166 is perpendicular to said base 164. In an example embodiment, the entire heat sink base 164 is in contact with the front plate 124, maximizing the dissipation of heat from the light sources 158. Heat at the front plate 124 can be dissipated to the support structure 106 through front plate 124 contact with the back plate 126 through the channel bottom plate 130. In an example embodiment the heat sink 160 comprises a heat conductive material such as aluminum.

The light source 158 can be provided to the heat sink 160 at the base 164, as shown in illumination component 157 of FIG. 8, at the endwall 166, as shown in illumination component 156 of FIG. 9, or at both the endwall 166 and the base 164 as shown in illumination component 159 of FIG. 10A. The angled relationship between the base 164 and the endwall 166 allows the light source 158 to be oriented at a desired angle with respect to the front plate 124, while still enabling the heat sink 160 to quickly transfer heat away from the light source 158 to the housing 122.

Having two lighting zones, namely the base 164 and the endwall 166, for accommodating light sources 158 provides a user with flexible lighting options that can be tailored to a desired application. Single or multiple rows of light sources 158 can be provided to the heat sink 160, or directly to the front plate 124 when no heat sink 160 is provided, to wash flat or vertical planes above the lighting assembly 120. In an example embodiment, an LED strip can have a rear backing configured to adhere to the heat sink 160; however, alternative ways to couple the light source 158 to the heat sink 160 or directly to the housing 122 are also contemplated. For example, a heat conductive adhesive can be applied to the heat sink 160, and an LED strip can be applied thereto. The lighting assembly 120 can be configured to provide white light as well as multiple colors of light that can be used to accent architectural details or enhance holiday themes.

The example illumination component 156 includes the lens 162 which can be variably shaped to maximize light output upward, outward or in a desired combination of directions to evenly illuminate the ceiling 104 above the lighting assembly 120 or provide a desired illumination pattern. By way of further example, the lens 162 can be shaped to maximize the distance light travels into a tray ceiling and/or reduce the likelihood of or diminish the intensity of hot spots directly above the lighting assembly 120. In general, depending on the size and configuration of a light fixture, lighting elements may not be disposed uniformly along its longitudinal dimension. As a result, some portions of the fixture may not produce as bright a light as other portions, causing dim areas to occur in the resulting light pattern produced. The lens 162 can diffuse light to avoid dim spots in the light pattern produced by the lighting assembly 120, and can protect the light sources 158 from dust and debris. The lens 162 can comprise a transparent material such as, but not limited to, glass, plastic, acrylic or other material that is of sufficient rigidity to couple the heat sink 160, while remaining sufficiently flexible to permit depression and/or manipulation by an operator when the lens is coupled to the heat sink 160, and the illumination component 156 is provided to the channel 128.

An illumination component can be configured to releasably engage the housing 122, allowing its removal and replacement through the aperture 132, obviating the need to remove the entire housing 122 should maintenance be required. In an example embodiment, light sources 158 adhere to the heat sink 160, and the lens 162 can be configured to engage the heat sink 160, allowing an illumination component to be removed from the housing 122 as a self-contained unit, further facilitating its removal. For example, referring to FIGS. 9, 10A and 10B, the lens 162 can comprise a back arm 168 terminating at a coupling rod 170 configured to engage a concave hollow 172 at the rear of the heat sink end wall 166. In addition, the lens 162 can have a spring arm 174, which, in an example embodiment, can be configured to friction fit a heat sink coupler 176 at the heat sink base 164. The spring arm 174 and the coupling rod 170 releasably engage the heat sink 160, allowing the illumination component 156 to be handled as a single unit.

In turn, an illumination component can releasably engage the housing 122 so that it remains secure while installed, but can be easily removed by an operator for maintenance. In an example embodiment, the lens 162 can have a bulge 178 configured to releasably fit a divot 180 at the back plate 126 to secure an illumination component. An illumination component can also releasably engage the front plate 124. Referring to FIGS. 8 and 9, in an example embodiment, the heat sink coupler 176 is in the form of a z-foot that can engage a housing coupler 182 at the front plate 124. In an example embodiment, the housing coupler 182 is embodied as an angled receptor, which the heat sink coupler 176 is configured to engage in a friction snap fit. In an example embodiment, the lens spring arm 174 can engage the heat sink coupler 176 as shown in FIG. 8. The lens spring arm 174 can impose a force that can maintain engagement of the lens 162 with the back plate 126 at the divot 180, and can maintain the engagement of the heat sink 160 and the front plate 124. When the lens 162 is coupled to the heat sink 160 through its engagement with the end wall 166, it can exert a force that can press and maintain the heat sink coupler 176 against the housing coupler 182 in a friction fit, locking the illumination component 156 in an engaged position at the housing 122. As can be seen from FIG. 9, engagement with the housing 122 is sufficient to maintain the illumination component 156 in position.

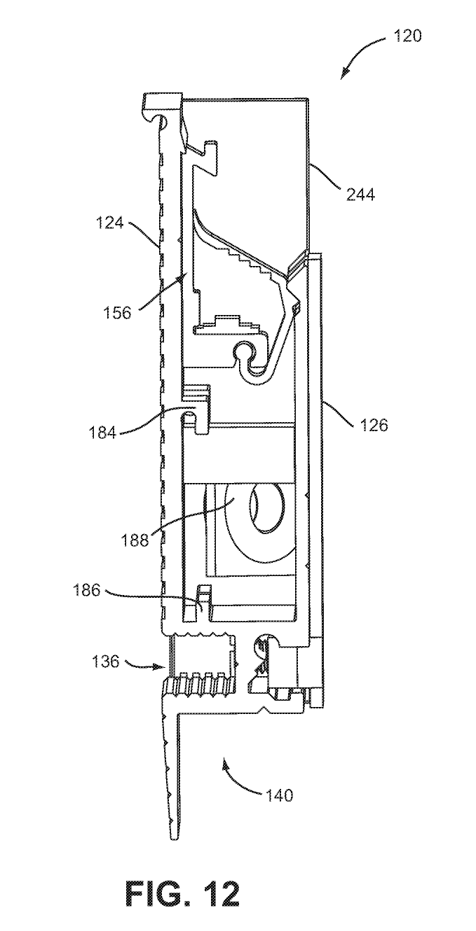

The heat sink coupler 176 can be of sufficient size to permit insertion of a tool, such as the flat blade of a screwdriver, against it to disengage it from the housing coupler 182. The curved bulge 178 of the lens 162 is configured to rest in the divot 180. As the heat sink base 164 is pushed back, the spring action of the lens spring arm 174 presses the curved bulge 178 up into the divot 180, pushing the heat sink 160 forward towards the channel aperture 132. As the coupler 176 is lifted over the housing coupler 182, the illumination component 156 is easily removed. Referring to FIGS. 11A, 11B, and 11C, the way the illumination component 156 engages/disengages the housing 122 can cause it to assume one of three positions with respect to the housing 122. Position 1, shown in FIG. 11A, is an outer disengaged position at which the illumination component 156 is within the channel 128 but not deep enough for engagement with the housing. Position 2, shown in FIG. 11B is an engaged position. Position 3, shown in FIG. 11C, is an inner disengaged position in which the illumination component 156 is deeper in the channel, too deep for engagement with housing coupler 182. More details regarding engagement of an illumination component at the housing 122 are contained in the previously referenced Doubek et al. “Floatline” application. It is contemplated that an illumination component can be releasably captured at a housing in a variety of ways, including, but not limited to, the use of springs and couplers at a housing or an illumination component.

In an exemplary embodiment, the lens 162 slopes toward the front lip 148 of the front plate 124, preventing accumulation of debris and facilitating cleaning and removal by an operator. The vertical depth of prior art coves often made it difficult to access the light fixtures they supported and concealed. The present invention provides an illumination component near the aperture 132 of the channel, making it easy to reach and wipe. Compare the prior art in FIG. 2 to the present invention depicted in FIG. 8. Dust and larger debris will roll off the lens of FIG. 8 instead of lying on top of the light source 158 and thus casting shadows. Additionally, any dust that does not roll off the lens is easily wiped away, and with gravity, falls to the floor since there is not a constructed cove to reach over to wipe the lens clean. By contrast, dust can accumulate on the light fixture 108 of FIG. 2. Furthermore, since the fixture in FIG. 2 is recessed in the constructed cove, the dust cannot simply drop to the floor. To the contrary, the prior art fixture requires a deliberate effort be made in order to remove dust or debris, for example a user must make the effort to vacuum the fixture. Nevertheless, while a sloped lens can offer various advantages, it is understood that a lens of a lighting assembly of the invention is not limited to such a configuration and may have alternative shapes and faces configured to provide various light distribution patterns as desired.

An illumination component can be configured to releasably couple the housing 122, for example at the back plate 126, with or without a lens. For applications in which there is a desire for lighting that is brighter than that which can be achieved with the use of a lens, it is contemplated that the invention can be practiced without a lens In such an embodiment, a heat sink end wall can comprise a spring component, such as but not limited to a spring arm (not shown), configured to force and maintain the heat sink coupler 176 in contact with the housing coupler 182. In an example embodiment, the housing 122 can be configured to receive, engage or otherwise cooperate with a spring component of a heat sink to secure lighting component within the housing 122. It is further contemplated that a spring component can be disposed elsewhere at a lighting assembly.

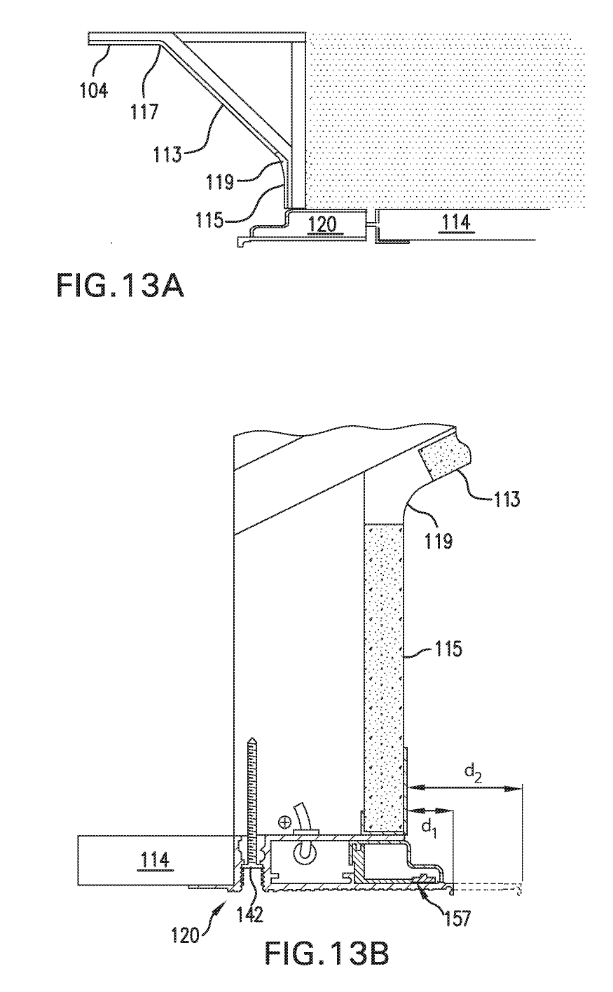

Control circuits and wiring for the illumination component 156, including source wiring from a power source, can be accommodated in a dedicated wireway 134 of the channel 128. Both the illumination component 156 and its associated wiring can be provided to the channel 128 through the aperture 132. In an example embodiment the channel 128 can be configured with one or more guides 184 that can separate the wireway 134 from the rest of the channel 128, as well as serve various other purposes. For example, the guide 184 can function as a backstop for the illumination component 156, preventing it from being pushed too far down in the channel 128. It can also guide or secure any wiring stowed in the wireway 134. In an example embodiment, the channel 128 can include the guide 184 as well as a lower guide 186 which can be used to secure wiring stowed within the channel 128. It is contemplated that the channel 128 can include additional features, such as a grommet 188 for strain relief as shown in FIG. 12. While depicted here in the form of an “L” shape, it will be clear to those skilled in the art that the guide 184 and lower guide 186 can be variably configured.

Accommodation of supply wiring within the housing 122 is a significant advantage of the present invention over the prior art. Prior art light fixtures typically connect external supply wiring to a series of interconnected LED arrays at a feed end of a light fixture. Unfortunately, the initial supply voltage decreases as it travels from array to array along the length of the fixture. As a result, arrays positioned near the end of the run can have a noticeable decrease in lumen output, causing dim or dark spots to appear. This problem can be of particular concern in regard to apparatus in which multiple housings are coupled together to provide a light fixture that spans the width of one or more walls. The present invention solves that problem by providing space for supply wiring within the channel 128 to permit multiple voltage connections for arrays within comprising series of multiple housings coupled together. Multiple supply wires can run in the wireway 134 allowing different supply wires to provide voltage to different arrays. Accordingly, all lighting elements can receive sufficient voltage to produce a desired lumen output without requiring space within a housing to accommodate a light source driver proximate a light source.

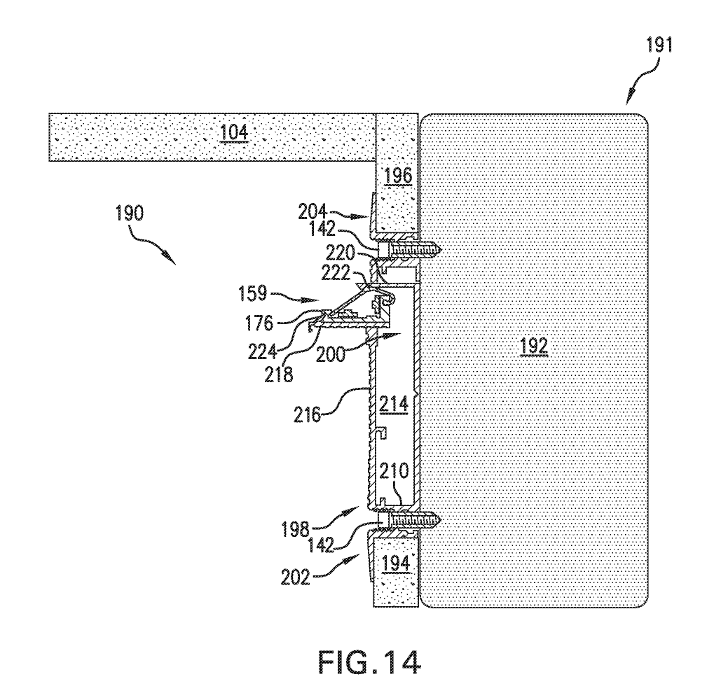

The housing 122 can be mounted so that it becomes part of a horizontal ceiling 114 provided at the support structure 106 (see FIG. 8); accordingly it can be referred to as a ceiling embodiment. The housing 122 can be configured to support the illumination component 156 beyond the vertical plane of the wall portion 112 to illuminate a horizontal plane, in this case the ceiling 104, without construction of a dedicated cove. However, it is contemplated that a lighting assembly of the invention can be provided to an environment with framing and walls that differ from those shown in FIGS. 1 and 8. For example, as shown in FIGS. 13A-13B, the lighting assembly 120 can be provided at the ceiling 114 and be configured to illuminate the ceiling 104. Instead of the vertical wall 112 connecting the ceiling 104 and the lower ceiling 114, a sloped planar surface or wall 113 may be disposed that extends between the upper ceiling 104 and a wall portion 115. In an example embodiment, a chamfer transition 117 having a radius of around 1.5″ can be disposed at the intersection of the sloped wall 113 and the ceiling 104 to smooth the transition between the two planar surfaces. Similarly, a chamfer transition 119 can smooth the intersection between the sloped wall 113 and the wall portion 115. As shown in FIGS. 13A, 13B, the distance at which an illumination component is cantilevered away from a wall or surface can depend on characteristics of the lighting devices used in the illumination component, e.g. type, size, color, etc., as well as the environment in which it is deployed, e.g. at vertical walls, sloped walls, etc. By way of example, but not limitation, the front plate 124 can extend outward beyond the wall 117 by around ¾″ for light sources in the form of white LEDs (depicted by distance d₁), and can extend out 2″ for a combination of white and RGB LEDs (depicted by distance d₂). When it is desired to illuminate both the wall 115 and the ceiling 104, light sources 158 can be disposed on the base 164 beyond the wall 115. When an illumination pattern in which the wall is not illuminated is desired, light sources 158 can be disposed at the endwall 166 of the heat sink 160 behind the wall 115.

In an example embodiment, the channel aperture 132 can have a knife edge (not shown) to further conceal the illumination component 156. For example, a knife-edged aperture may be preferred when a large light source, such as a light guide panel, is employed, or when LEDs are disposed at the heat sink endwall 166 and directed outward and a sloped reflector is used.

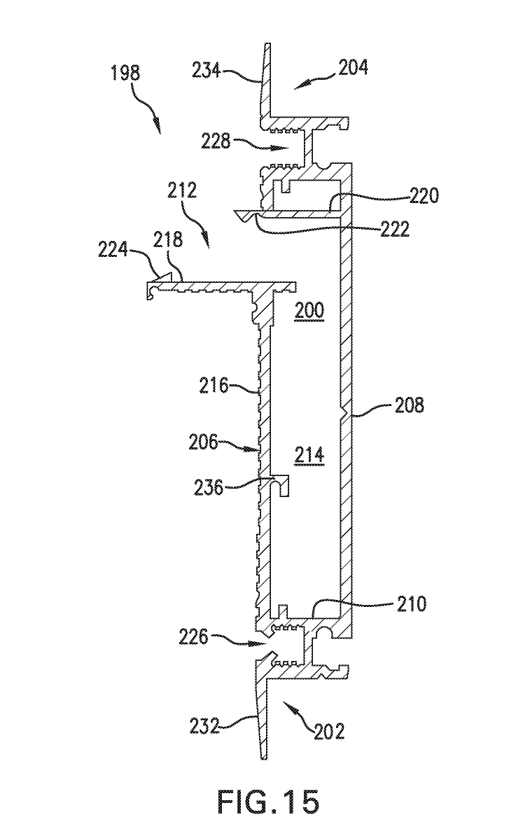

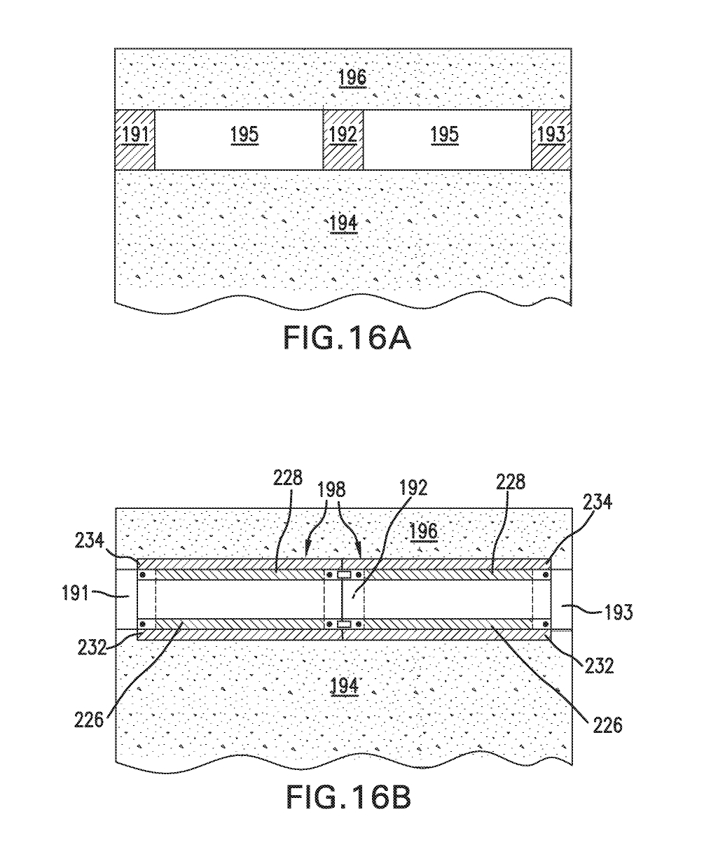

FIG. 14 depicts a wall mount embodiment 190 of the invention, which, as will be discussed below is particularly advantageous when used in conjunction with crown molding. As was the case for the ceiling mount embodiment 120, a wall mount embodiment can support an illumination component beyond a vertical plane to illuminate a ceiling or horizontal plane above it without a dedicated constructed cove. However, in a wall mount embodiment, a mounted lighting assembly can become part of a wall, rather than a ceiling, at a support structure, and can provide a wireway in a wall below a ledge of light sources. Referring to FIGS. 14, and 15, a wall mount lighting assembly 190, configured to illuminate the ceiling 104 is mounted at a support structure 191 comprising framing 192 at a wall having first wall portion 194 and second wall portion 196. The lighting assembly 190 comprises a housing 198 and the illumination component 156.

The housing 198 comprises a channel 200, a first end cap 202, and a second end cap 204. The housing 198 is configured to cooperate with first and second wall portions 194, 196 to provide a wall at the framing 192. For example, the housing 198 can be provided to a gap in a wall between first and second wall portions 194, 196, with caps 202, 204 receiving first and second wall portions 194, 196 respectively. The housing 198 can occupy the gap between first and second wall portions 194 and 196, and can be concealed with spackling and paint to become an integral part of a wall comprising the assembly 190 and the wall portions 194, 196. The housing 198 comprises a front plate 206, a back plate 208, and a channel bottom plate 201 that bound the channel 200. An aperture 212 provides access to the channel 200.

As was the case for the ceiling embodiment, the channel 200 of the wall embodiment 190 provides a wireway 214 that accommodates wiring and control circuits associated with the illumination component 156, including supply wiring. Wiring can be provided to the channel 200 through the aperture 212. The front plate 206 comprises a plate wall portion 216 and a plate support portion 218. The plate wall portion 216 cooperates with the back plate 208 to define the channel 200 and, when installation of the lighting assembly 190 is complete, cooperates with first and second wall portions 194, 196 to form a wall at the framing 192. The plate support portion 218 is disposed at an angle with respect to the plate wall portion 216. By way of example, but not limitation, the plate wall portion 216 and the plate support portion 218 can be orthogonal, as shown in FIGS. 14-15. The plate support portion 218 is configured to support an illumination component, such as, but not limited to, the illumination component 156 used in the ceiling embodiment. As can be seen in FIG. 14, the plate support portion 218 can support illumination component 156 beyond the second wall portion 196 vertical plane to illuminate the ceiling 104. FIGS. 14 and 15 depict the wireway 214 “below” the illumination component 156, however, this is not to be interpreted as a limitation since it is contemplated that their relative positions can be reversed. For example, the plate support portion 218 can be disposed proximate the cap 202, with the wireway 214 provided between the front and back plates 206, 208 above it.

As was the case for the ceiling embodiment 120 discussed previously herein, the illumination component 156 can be configured to releasably engage the housing 198. For example, bulge member 178 at the lens 162 can engage a channel endwall 220 at a divot 222. In addition, the coupler 176 at the heat sink base 164 can engage a housing coupler 224 at the plate support portion 218.

Like the ceiling embodiment 120, the wall embodiment 190 of a lighting assembly can comprise two separate mounting zones for mounting the housing 198. A first mounting zone can be in the form of a first mounting trough 226 adjacent the channel bottom plate 210, and the second mounting zone can be in the form of a second mounting trough 228 at an opposing end of the housing 198. Both the first and second troughs 226, 228 can be configured to receive a mounting screw 230 such as a drywall screw to attach the housing 198 to the framing 192 without penetration of the channel 200, the front plate 206 or the back plate 208. In an example embodiment, at least one mounting trough has a countersunk face, so that a mounting screw can lie flush with the trough obviating the need for an operator to drill a countersunk hole.

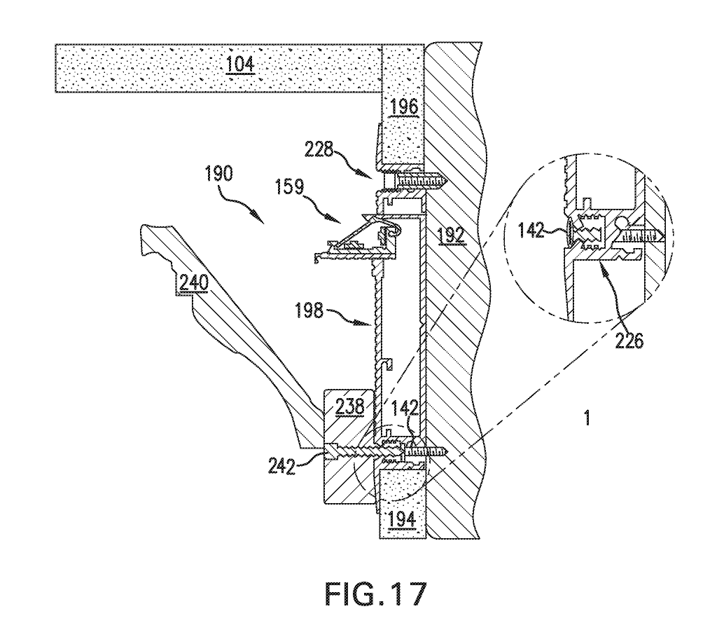

Mounting the housing 198 to the framing 192 through the first and second troughs 226, 228 stabilizes the housing 198 and reduces the likelihood that it will shift or rock vertically or horizontally. It is further noted that the first and second caps 202, 204 can assist in maintaining the positioning of/and or supporting a lighting assembly. For example, it is contemplated that the housing 198 may be positioned to extend across space between two framing structures FIG. 16A shows a first framing stud 191, a second framing stud 192 and a third framing stud 193. A gap 195 exists between the first wall portion 194 and the second wall portion 196. The housing 198 can be arranged so that it is attached at the framing studs 191 and 192, extending across the space between them in the gap 195. By way of example, two housings 198 can be mounted to the framing stud 192 and coupled together as shown in FIG. 16B. Alternatively, it is contemplated that a lighting assembly can be mounted to a first stud and coupled to a lighting assembly that is mounted at a second stud, to span the distance between the first and second studs.

In a wall embodiment, the first and second caps 202, 204 can maintain and support portions of assembly housings that are not attached to framing by receiving and fitting against first and second wall portions 194, 196. In a ceiling embodiment, the cap 140 can receive the ceiling portion 114 which can support the housing 122 when it extends across space between framing.

The housing 198 comprises a first flange 232, as part of the first cap 202 at a first end, and a second flange 234, as part of the second cap 204 at an opposing end. After the housing 198 is mounted, the front plate 206 and the two flanges 232, 234 can be mudded, sanded and painted to blend with the first and second wall portions 194, 196. Accordingly, each can have a corrugated surface to better retain the drywall mud. Here again, the lighting assembly 190 conceals itself to provide cove lighting without cove construction. It is in effect its own cove.

When providing an illumination component to the housing 198, its wiring can be coupled with source wiring, and the spliced wiring provided to the wireway 214 through the aperture 212. In an example embodiment, the wireway 214 can include one or more guides 236. The illumination component 156 or 157 can be provided to the support portion 218 and engaged at the housing 198.

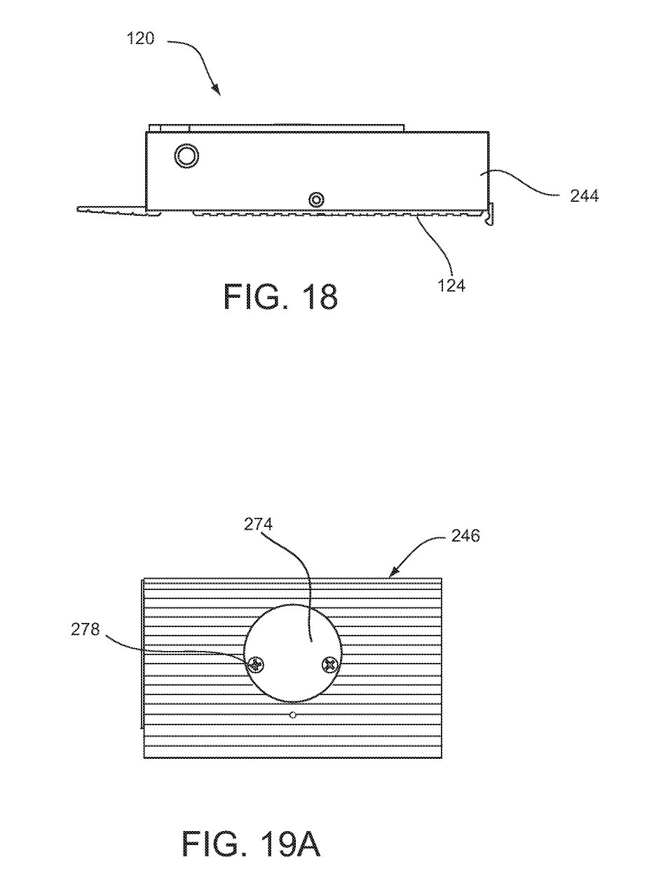

In some instances it is desirable to illuminate a ceiling from behind crown molding. The present invention is particularly well-suited for this type of application. In an example embodiment, crown molding can be mounted at structural framing, such as standard wood framing studs, through a housing of the invention. For example, referring to FIG. 17, a molding base 238 can be attached to the housing 198, and crown molding can subsequently be attached to the molding base 238. The molding base 238 can be in the form of wood, medium density fiberboard (mdf), or any other material of sufficient strength, rigidity and smoothness for attaching crown molding thereto. In an example embodiment a mounting screw 142 used to attach the housing 198 to the framing 192 at the trough 226 can be configured to receive a coupling means configured to couple the molding base 238 to the housing 198. For example, the trough 226 and the mounting screw 142 can be sized to receive the coupling screw 242 that is screwed through the molding base 238 into the head of the mounting screw 142. Through the forces applied by the coupling screw 242 and the mounting screw 142 the molding base 238 is secured at the framing 192. Crown molding 240 can then be attached to the molding base 238, for example, the crown molding 240 can be nailed to the molding base 238. The crown molding 240 can conceal the lighting assembly 190, effectively providing a cove for it so that a cove lighting effect can be provided without construction of a dedicated cove. In an example embodiment, at least one of the mounting troughs 226, 228 has a face that is counter sunk so that a mounting screw head can lie flush with the housing. Thus the present invention provides a lighting assembly that can be concealed behind crown molding and still dissipate heat.

As discussed above in regard to the ceiling mount embodiment 120, the mounting trough 226 of the wall mount embodiment 190 can be used to coupled adjacent housings together. By way of example, but not limitation, the face of the trough 226 can be drilled large enough to receive a barrel nut for coupling a coupling bolt that couples two adjacent housings 198 at the trough 226, as shown in FIG. 16B.

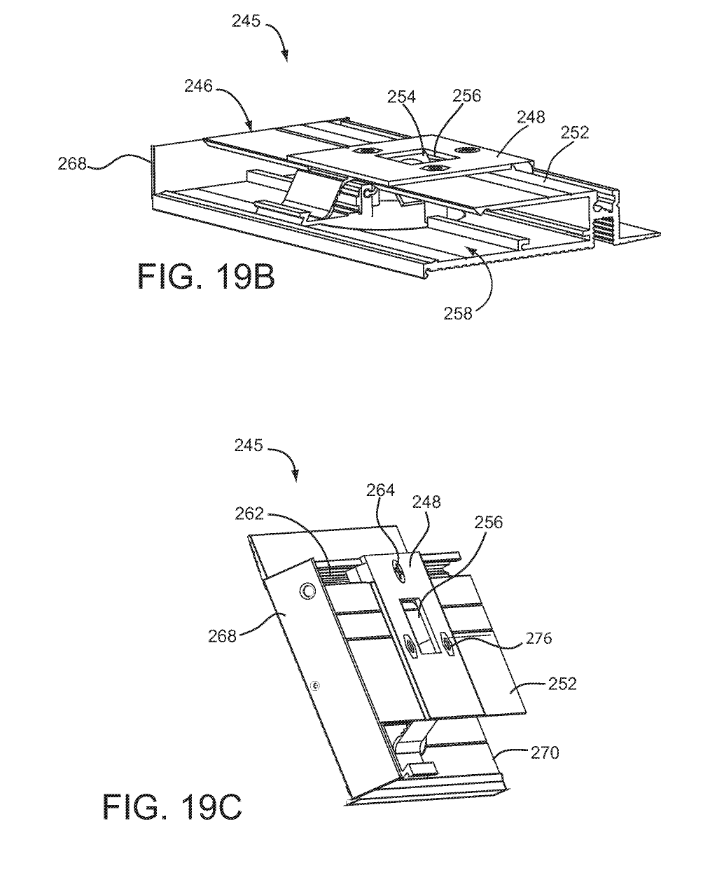

It is contemplated that a housing can further include a sidewall 244, as shown in FIG. 18 at one or more ends of its longitudinal dimension or length to conceal the contents of a channel. In an example embodiment, the sidewall 244 can be attachable and/or removable by an operator. In an example embodiment, a housing can comprise mitered ends (not shown) to facilitate positioning adjacent housings at corners. Prior art devices, even those that employ a knife edge to provide a smaller profile and better conceal fixture contents, can have gaps at corners where runs of light fixtures terminate. However, when present lighting assemblies are used to form a square around a tray ceiling, mitered ends can be mudded over to provide a ceiling plane without the gaps of the prior art devices.

As will be explained in further detail below, the invention's accommodation of feed wiring within its housing also facilitates its installation at a pre-existing wall, ceiling, or other architectural structure. In prior art devices, feed wiring that provides electricity to a light fixture is typically connected to light fixture wiring at a junction box behind a wall, ceiling or floor of a building. Problems can arise when there is no room for a junction box at a desired installation location, or when the light fixture, once mounted, prevents future service access to the junction box. By accommodating feed wiring within itself, a lighting assembly of the present invention obviates the need to consider accommodation of a junction box at a desired location, and allows easy access to the electrical connections between feed wiring and apparatus wiring should future servicing be required.

Referring back to FIG. 3, feed wiring of sufficient length for splicing with apparatus wiring can be pulled into the housing 122, and can be pulled through a plurality of coupled housings 122, such as those shown in FIG. 7. The width of the channel 128 may require that a feed cable be bent sharply upon its entry into the housing 122. Preferably, the feed cable should be protected from sharp edges that can damage the cable or cause a short circuit. Once inside the housing 122, the feed wiring may need to be trimmed by an installer. In addition, it is preferable that some form of strain relief be provided to secure the wiring so that the spliced connections are not compromised by an installer tugging or pushing on the feed wiring or apparatus wiring. An embodiment of the invention can be configured to address any or all of these considerations.

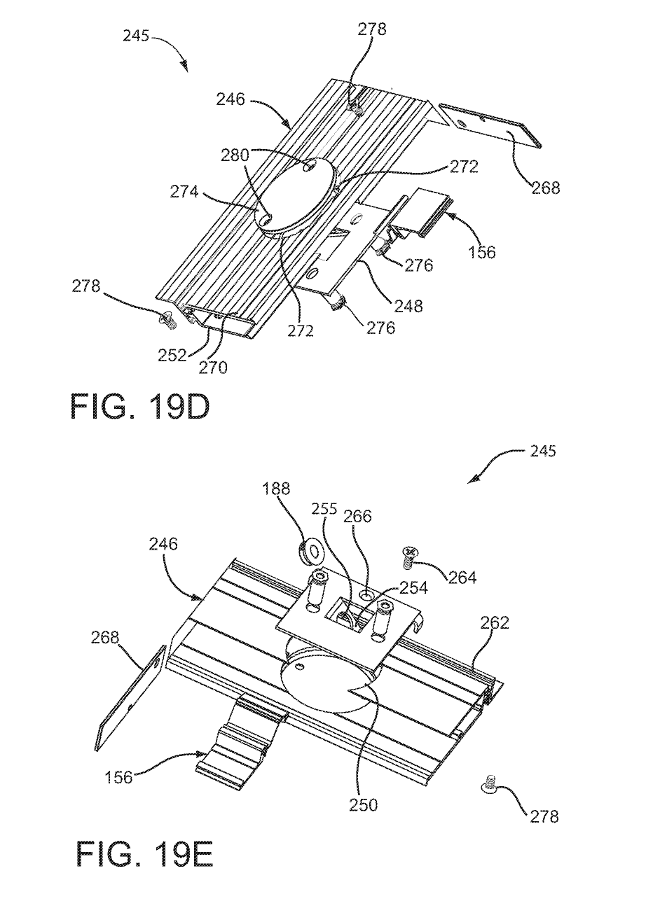

FIGS. 19A-19E show various views of an example embodiment 245 of a lighting assembly. FIG. 19A shows a front view of the example lighting assembly 245, FIGS. 19B and 19C show perspective views, and FIGS. 19D and 19E show exploded views. As shown in the drawings, by way of example, a housing 246 can include a rear access panel 248 configured to cover a rear gap or aperture 250 at the back plate 252 through which feed wiring can enter the housing 246. More specific details regarding access panels at a housing of the invention are described in the “Floatline Lighting Assembly”, application previously referenced.

As discussed previously herein, it is contemplated that in some embodiments, a longitudinal length of a lighting assembly housing can span the distance between two framing supports so that a portion of a housing is in contact with a framing stud, and a portion of the housing extends across the space between studs. In such a configuration, a portion of the back plate 252 is free of contact with the framing. Accordingly, within the space between framing studs source wiring can be provided to the rear aperture 250.

The rear access panel 248 can include a tab 254 configured to angle into the housing 246 through a panel opening 256. The tab 254 can be configured with a tab aperture 255 configured for passage of the feed wiring into the channel 258. By way of example, the tab aperture 255 can be fitted with a smooth-surfaced grommet 188 (best seen in FIG. 12). The smooth curved surface of the grommet 188 allows the feed cable to be pulled through the rear access panel 248 and turned at a sharp angle into the housing 246, while protected from nicks and cuts. The grommet 188 can also provide strain relief for the feed cable after it has been pulled inside, and after it has been spliced with apparatus wiring.

In an example embodiment, the rear access panel 248 can be removably coupled to the housing 246 and can include one or more arms 260 configured to be received and friction fitted at a rear gutter 262 of the housing 246. In addition, the rear access panel 248 can include one or more holes configured to receive a screw or other coupling means configured to couple the rear access panel 248 to the housing 246. As shown in FIGS. 19C, 19E, a screw 264 can be received at a hole 266 and further received at the rear gutter 262. In an example embodiment, the housing 246 can include a sidewall 268 at one or both ends, extending between a front plate 270 and a back plate 252.

Referring to FIGS. 19A and 19D, the example embodiment 245 further includes a front aperture 272 at the front plate 270 that is covered by a removable access panel 274. In an exemplary embodiment, the front access panel 274 and the front aperture 272 can have a round shape. Various means can be employed to secure the front access panel 274 at the housing 246. For example, the rear access panel 248 can be fitted with one or more Pem studs 276 that can be configured to receive screws 278 provided to the front access panel 274 through holes 280. The employment of the Pem studs 276 provides the additional advantage of preventing the front access panel 274 from falling into channel 258. The front access panel 274 can be completely removed to allow an installer to reach into the channel 258 through the front aperture 272 and pull feed wiring through the grommet 188 while lifting and/or supporting the housing 246 at a wall or ceiling during or after the housing is mounted at framing.

It is preferable that the front aperture 272 be disposed in an arrangement with respect to the rear aperture 250 that facilitates an installer reaching through the front aperture 272 and pulling feed wiring into the channel 258 through the rear aperture 250 and the grommet 188. In an example embodiment, the front access panel 274 and/or the rear access panel 248 can comprise a ferrous material such as steel that can be detected by a magnet. This allows an operator tasked to service an embedded assembly to find the location of spliced wiring in a wall, ceiling or other structure simply by running a magnet over the area at which the apparatus is embedded.

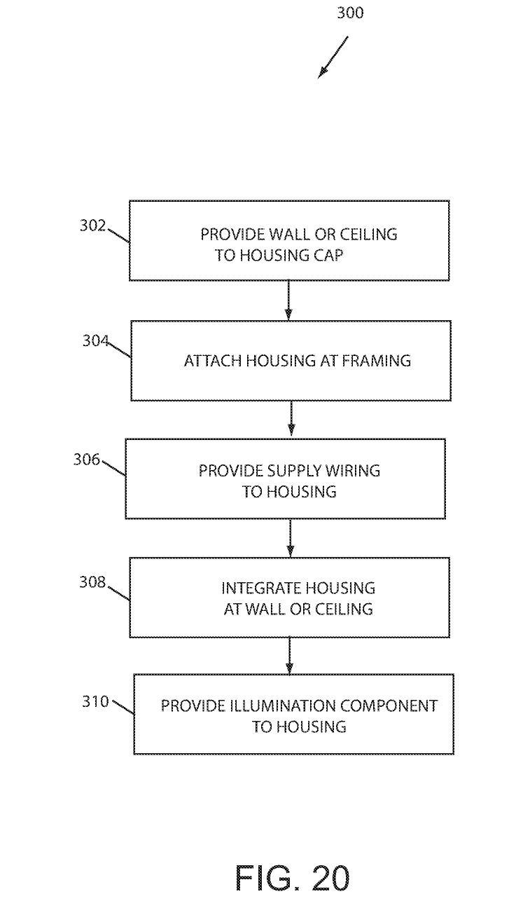

FIG. 20 depicts a flow diagram of an example method 300 for practicing the present invention to provide a cove lighting effect without constructing a cove. At block 302, a portion of an existing wall or ceiling can be provided to a housing. For example, the housing 122 can receive the ceiling portion 114 at the cap 140. At block 304, a housing can be attached to structural framing. For example, referring to FIGS. 5 and 8, the housing 122 can be attached to framing 116 by providing a mounting screw 142 at the mounting hole 144 at the trough 136, and a mounting screw 142 to the mounting hole 144 at the flange 138 that penetrates the ceiling portion 114 and the framing 116.

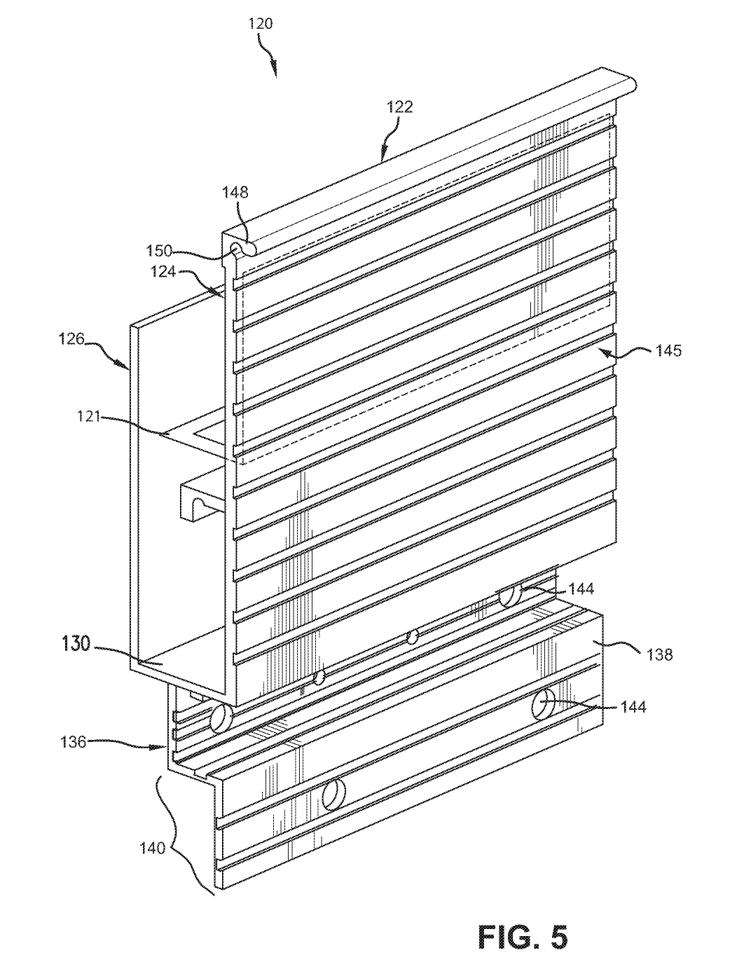

At block 306, supply wiring can be provided to the mounted housing. For example, supply wiring from a power source can be provided to the housing 122 at the channel aperture 132 (FIG. 4) or through the rear access aperture 250 via the tab 254 and the grommet 188. At block 308 a housing can be integrated to appear as part of a ceiling or wall to effectively become a cove for a light source. The front plate 124 and the flange 138, and even the trough 136, can be mudded, sanded and painted to blend and cooperate with the ceiling portion 114 to provide a generally horizontal surface that appears a ceiling to a room occupant below it.

At block 310, an illumination component can be provided to a housing. For example, wiring of the illumination component 156 can be coupled with source wiring present at the channel 128. The illumination component 156 can be provided to the housing 122 through the channel aperture 132 and releasably engage the housing 122. For example, the lens bulge 178 of the lens 162 can engage the divot 180 at the back plate 126. The heat sink coupler 176 of the heat sink 160 can engage the housing coupler 182 at the front plate 124. Embedding a housing prior to providing an illumination component to the housing protects the illumination component from the drywall mud, sanding dust, and other debris present during the integration process. However, it is contemplated that an illumination component can also be provided to a housing prior to its integration at a wall or ceiling.

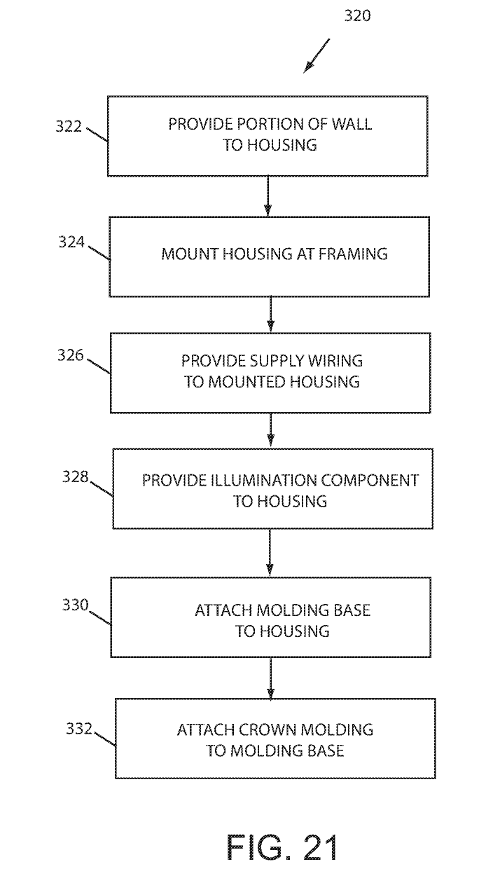

FIG. 21 shows an example method 320 of practicing the invention to provide a cove lighting effect at crown molding. At block 322, a portion of a room's wall can be provided to a housing. For example, the housing 198 can be positioned at a first framing stud 191, and at a second framing stud 192, at the gap 195 between the first wall portion 194 and the second wall portion 196. The first cap 202 of the housing 198 can receive a first wall portion 194, and the second cap 204 can receive the second wall portion 196.

At block 324 a housing can be mounted at framing for the wall or ceiling. For example, a first mounting screw 142 can be provided at a mounting hole in the trough 226 to attach the housing 198 to the framing stud 192, likewise a second mounting screw 142 can be provided to the second trough 228 to attach the housing 198 to the framing stud 192.

At block 326, supply wiring can be provided to a housing. For example, supply wiring from a power source can be provided to the channel 200 of the housing 198 at the channel aperture 212. It is noted that supply wiring can also be provided via the rear aperture 250 as described above.

At block 328, an illumination component can be provided to the mounted housing. For example, wiring for the illumination component 156 can be coupled to the source wiring at the channel 200. The spliced wiring can then be pushed back through the channel aperture 212 into the wireway 214. The illumination component 159 can be provided to the plate support portion 218 at the front plate 206 so that it engages the housing coupler 224 at the plate support portion 218 and the divot 222 at the channel endwall 220.

At block 330, a molding base can be attached to a housing. For example, a fastener such as a screw can be applied to penetrate the molding base 238 and forcefully contact, and preferably engage, the mounting screw 142 at the mounting trough 226 to couple the molding base 238 to the framing 192 through the housing 198. At block 332, crown molding can be attached. For example, a fastener such as a screw or a nail is applied to the crown molding 240 to attach it to the molding base 238.

In method 320, the crown molding 240 is used to conceal the lighting assembly 190, i.e. to provide a cove for it, so it is not necessary to conceal the housing 198 by mudding and painting the front plate 206. However, it is contemplated that an operator may want to embed the housing 198 at a wall prior to installing the crown molding.

The invention provides apparatus and methods that provide cove lighting without cove construction. Rather than being supported by a constructed cove having a bottom for supporting a light fixture, an apparatus of the invention is supported by pre-existing structural framing for a wall or ceiling. Rather than being hidden or concealed by a sidewall of a cove, an apparatus is made to appear as part of the wall or ceiling.

A lighting assembly can comprise a housing having a depth or thickness that allows and facilitates its integration at a wall or ceiling. The housing can be provided at a gap in a wall or ceiling and can be attached to structural framing that supports the wall or ceiling. Its housing can receive portions of the wall or ceiling that border the gap, and can be mudded and painted to appear as part of the wall or ceiling at which it is mounted. No additional construction is required to support or conceal the lighting assembly. This built-in or self-cove aspect that results from a housing being integrated with a wall or ceiling to appear as part of the wall or ceiling provides seamless lighting around a room's perimeter. Thus the invention avoids the visible and distracting seams that plague prior art fixtures having long lengths that attempt to provide cove lighting without an actual cove.

A lighting assembly can comprise a channel that can accommodate an illumination component and wiring associated with the illumination component, including source wiring. Wiring can be provided to the channel via an aperture at the top of the channel or through a rear aperture. An illumination component that can comprise simply a light source, or some combination of light source, heat sink and lens can be provided to the channel through the channel aperture. In an example embodiment, a light source attaches to a heat sink, and the heat sink and a lens are configured to releasably engage so that the light source, heat sink and lens can be handled as a single unit. A housing can be configured to releasably engage an illumination component so that the illumination component can be easily provided to and removed from the housing for maintenance without removal of the entire lighting assembly. In an example embodiment, a housing supports an illumination component on a surface that is parallel with a ceiling to be illuminated.

A mounting trough at the housing enables the housing to be attached to framing without penetration of the housing front plate, back plate, or channel. In an example embodiment, a housing can have two separate mounting zones for attaching a housing to structural framing. The trough can also be used to positively couple adjacent housings to accommodate long runs of lighting.

The invention can be practiced in various embodiments. By way of example, but not limitation, a ceiling mount embodiment can be disposed at a gap at a ceiling and configured to attach to structural framing at a ceiling. A first end of a housing can comprise a cap for receiving the edge of the ceiling that borders the gap. An opposing end of the housing can support an illumination component. The housing can be arranged so that a portion of it cantilevers beyond a vertical, horizontal or sloped surface to illuminate a ceiling above it. A first mounting zone can be in the form of a mounting trough, and the second mounting zone can be in the form of a flange of the cap.

A wall mount embodiment can be used in conjunction with crown molding. A housing can be attached to structural framing at a wall. A base can be attached to the housing at a mounting trough. Crown molding can be attached to the base so that the molding is attached to structural framing through the housing. Light from an illumination component that can include a heat sink can shine from behind the crown molding while the crown molding conceals the illumination component. A housing can be positioned at a gap in a wall so that a first cap at a first end of the housing receives a first edge of the gap, and a second cap at an opposing end of the housing can receive an opposing edge of the gap. A housing can include a first mounting trough proximate the first cap, and a second mounting trough at an opposing end of the housing proximate the second trough.

In addition to the channel aperture, an example embodiment can have front and rear access apertures at front and back plates of a housing. An operator can use the front and rear access apertures to pull source wiring from behind the housing into the channel, and even out through the front plate.

As required, illustrative embodiments have been disclosed herein, however the invention is not limited to the described embodiments. As will be appreciated by those skilled in the art, aspects of the invention can be variously embodied, for example, modules and programs described herein can be combined, rearranged and variously configured. Methods are not limited to the particular sequence described herein and may add, delete or combine various steps or operations. The invention encompasses all systems, apparatus and methods within the scope of the appended claims.

1. A lighting assembly, comprising:
a housing configured for integration at a wall or ceiling, said housing having a front plate and a back plate defining a channel therebetween, a first mounting zone, and a cap;
an illumination component comprising a light source;
wherein said mounting zone is configured to receive a means for attaching said housing to structural framing supporting said wall or said ceiling; and
wherein said cap is configured to receive a portion of said wall or said ceiling.

2. The assembly of claim 1, wherein said illumination component further comprises a heat sink.

3. The assembly of claim 2, wherein said heat sink comprises an endwall and a base, and said light source is receivable at said base or said endwall.

4. The assembly of claim 1, wherein said housing supports said illumination component at a surface parallel to said ceiling.

5. The assembly of claim 1, wherein, when installed, a portion of said housing cantilevers beyond a vertical or sloped surface.

6. The assembly of claim 1, wherein said channel comprises a wireway that accommodates wiring for said illumination component.

7. The assembly of claim 1, wherein said housing comprises a second mounting zone.

8. The assembly of claim 1, wherein said light source is coupled directly to said housing.

9. A housing, comprising:
a channel that accommodates a light source and its wiring;
a mounting trough that receives a means for mounting said housing to framing without penetration of said channel;
a cap that receives a portion of ceiling supported at said framing; and
wherein said housing has a channel thickness substantially the same as said ceiling.

10. The housing of claim 9, wherein said housing comprises a front plate and a back plate that provide said channel therebetween.

11. The housing of claim 9, wherein said cap comprises a sidewall of said trough and a flange perpendicular to said sidewall.

12. The housing of claim 9, wherein said housing is configured to releasably engage an illumination component comprising said light source.

13. The housing of claim 9, wherein when mounted at said framing, said back plate abuts said framing.

14. A housing, comprising:
a front plate and a back plate with space therebetween providing a channel bounded by a channel bottom plate, said channel providing a wireway that accommodates wiring for a light source;
a first mounting trough that receives a means for attaching said housing to structural framing without penetration of said channel;
a first cap at a first end of said housing, configured to receive a first portion of a wall supported at said framing; and
a second cap disposed at an opposing end of said housing, configured to receive a second portion of said wall supported at said framing.

15. The housing of claim 14, wherein, when mounted at a structure, said back plate abuts a surface of said framing.

16. The housing of claim 14, wherein said housing supports a light source at a surface parallel to a ceiling that is to be illuminated.

17. The housing of claim 14, further comprising a second mounting trough disposed at said opposing end, that receives a means for attaching said housing to said framing.

18. The housing of claim 14, wherein said housing is configured to attach a molding base at which crown molding can be attached.

19. The housing of claim 14, wherein said front plate includes a plate wall portion and a plate support portion angled with respect to said plate wall portion.

20. An illumination component, comprising:
a heat sink having a base and an endwall oriented at an angle with respect to said base;
a light source configured to provide light; and
wherein at least one of said base and said endwall are configured to receive and accommodate said light source.

21. The illumination component of claim 20, further comprising a lens.
